(19) United States
(12) Patent Application Publication
(10) Pub. No.: US 2023/0199237 A1
(43) Pub. Date: Jun. 22, 2023

(54) BROADCAST CONTENT PRODUCTION SYSTEM, BROADCAST CONTENT PRODUCTION METHOD, AND PROGRAM

(71) Applicant: SONY GROUP CORPORATION, TOKYO (JP)

(72) Inventors: KAZUHIKO TAKABAYASHI, TOKYO (JP); YASUAKI YAMAGISHI, TOKYO (JP)

(21) Appl. No.: 17/998,673

(22) PCT Filed: May 14, 2021
(86) PCT No.: PCT/JP2021/018335

§ 371 Date: Nov. 14, 2022

(30) Foreign Application Priority Data
May 27, 2020 (JP) 2020-091972

(51) Int. Cl. H04N 21/242; H04N 21/218

(52) U.S. Cl. CPC H04N 21/242; H04N 21/218

(57) ABSTRACT

The present disclosure relates to a broadcast content production system, a broadcast content production method, and a program that are capable of avoiding occurrence of inconvenience in a broadcast content. The clock accuracy recognition unit recognizes accuracy of a clock of each of a plurality of video sources, and a time difference estimation and correction unit estimates a time difference of a stream from the video source with low accuracy of clock and corrects the time difference. Furthermore, a processing content control unit controls a processing content of production processing of the broadcast content in accordance with the accuracy of the clock of each of the video sources recognized by the clock accuracy recognition unit and with accuracy of time information, of each stream, having being corrected by the time difference estimation and correction unit. The present technology can be applied to, for example, a broadcast content production system using IP connection.

### TECHNICAL FIELD

The present disclosure relates to a broadcast content production system, a broadcast content production method, and a program, and more particularly, to a broadcast content production system, a broadcast content production method, and a program that are capable of avoiding occurrence of inconvenience in a broadcast content.

### BACKGROUND ART

In recent years, the resolution of broadcast contents has been increased, and the amount of data handled in a production environment of broadcast contents has become enormous. Accordingly, a previously used connection using a dedicated coaxial cable (SDI: serial digital interface) between devices is being replaced by a network using the internet protocol (IP) on the Ethernet, which is increased in speed and capacity. Conventionally, equipment and the like in station buildings of broadcasting stations have been mainly made to be compatible with the IP. However, virtualization and cloudification of various types of media processing that are related to content production and are performed in equipment in station buildings or the like have been studied and are being put into practical use for some areas.

Furthermore, a demonstration experiment for utilizing a 5G mobile communication network has also been conducted particularly in production of relay broadcasting of sports, entertainment live shows and events, and the like. For example, in 3GPP, which is a standardization organization of mobile communication standards, broadcasters, an industrial association (European Broadcast Union (EBU)), broadcast production equipment vendors, and the like are playing a central role to discuss standard requirements to utilize 5G in broadcast content production (see Non-Patent Document 1, for example).

On the other hand, due to a rise of streaming distribution as a so-called over the top (OTT) service, internet distribution of sports, entertainment live shows and events, and the like for which broadcast has been conventionally a main distribution means has been generalized. At the present time, production by conventional broadcasters is advantageous from the viewpoint of content production quality; however, it is considered that the difference will be reduced, and the broadcaster is attempting to incorporate various production technologies that are not on the extension of the conventional technologies.

In particular, in a case where a 5G wireless connection, which does not require a fixed wiring, it is being considered to utilize more videos and audio sources than before. Furthermore, it is assumed that, in that utilization, not only such dedicated equipment as used in conventional broadcast content production but also general user devices such as smartphones and applications are used as sources of videos and audios in content production.

### CITATION LIST

### Non-Patent Document

Non-Patent Document 1: 3GPP TR 22.827 V17.1.0 (2020/01)

### SUMMARY OF THE INVENTION

### Problems to be Solved by the Invention

Meanwhile, in the conventional broadcast content production, it is a precondition that each video source operates in synchronization with a single master clock. However, in a case where a smartphone, an application of the smartphone, and the like are used as a video source, such a precondition is not always satisfied. Therefore, when a content is produced using, as video sources, various devices having different clock accuracy, inconvenience may occur in a processed broadcast content depending on the content of production processing.

The present disclosure has been made in view of such a situation, and makes it possible to avoid occurrence of inconvenience in a broadcast content even in a case where various devices having different clock accuracy are used as video sources.

### Solutions to Problems

A broadcast content production system of an aspect of the present disclosure includes: a clock accuracy recognition unit that recognizes accuracy of a clock of each of a plurality of video sources; and a time difference estimation and correction unit that estimates a time difference of a stream from a video source, of the plurality of video sources, with low accuracy of clock and corrects the time difference.

A broadcast content production method or program of an aspect of the present disclosure includes: recognizing accuracy of a clock of each of a plurality of video sources; and estimating a time difference of a stream from a video source, of the plurality of video sources, with low accuracy of clock and correcting the time difference.

In an aspect of the present disclosure, accuracy of a clock of each of a plurality of video sources is recognized, a time difference of a stream from a video source having low accuracy of clock is estimated, and the time difference is corrected.

### BRIEF DESCRIPTION OF THE DRAWINGS

FIG. 1 is a block diagram illustrating a configuration example of a typical broadcast content production system.

FIG. 2 is a block diagram illustrating a configuration example of a content production system assuming a 5G wireless network.

FIG. 3 is a diagram illustrating synchronization adjustment by a buffer.

FIG. 4 is a block diagram illustrating a configuration example of an information processing device that performs synchronization processing to which the present technology is applied.

FIG. 5 is a diagram illustrating FLUS Source Capability Discovery.

FIG. 6 is a diagram illustrating a definition of capability.

FIG. 7 is a diagram illustrating an example of an ISOBMFF segment including a ‘prft’ box.

FIG. 8 is a diagram illustrating an example of a syntax of the ‘prft’ box.

FIG. 9 is a diagram illustrating an example of expansion of a timestamp.

FIG. 10 is a diagram illustrating an example of a value of a time_source field.

FIG. 11 is a diagram illustrating a definition of a syntax of an ‘nrft’ box.

FIG. 12 is a diagram illustrating an example of Semantics.

FIG. 13 is a diagram illustrating an example of an ISOBMFF segment to which an ‘nrft’ box is added.

FIG. 14 is a block diagram illustrating a configuration example of a broadcast content production system to which the present technology is applied.

FIG. 15 is a diagram illustrating a definition of a syntax of an ‘nrft’ box.

FIG. 16 is a diagram illustrating an example of Semantics.

FIG. 17 is a diagram illustrating an example of a time accuracy label to be attached to a stream.

FIG. 18 is a diagram illustrating a display example of a monitor screen.

FIG. 19 is a diagram illustrating an example of processing content of content production processing to be set for each time accuracy label.

FIG. 20 is a flowchart for illustrating information processing.

FIG. 21 is a block diagram illustrating a configuration example of an embodiment of a computer to which the present technology is applied.

### MODE FOR CARRYING OUT THE INVENTION

Hereinafter, specific embodiments to which the present technology is applied will be described in detail with reference to the drawings.

<Configuration Example of Broadcast Content Production System>

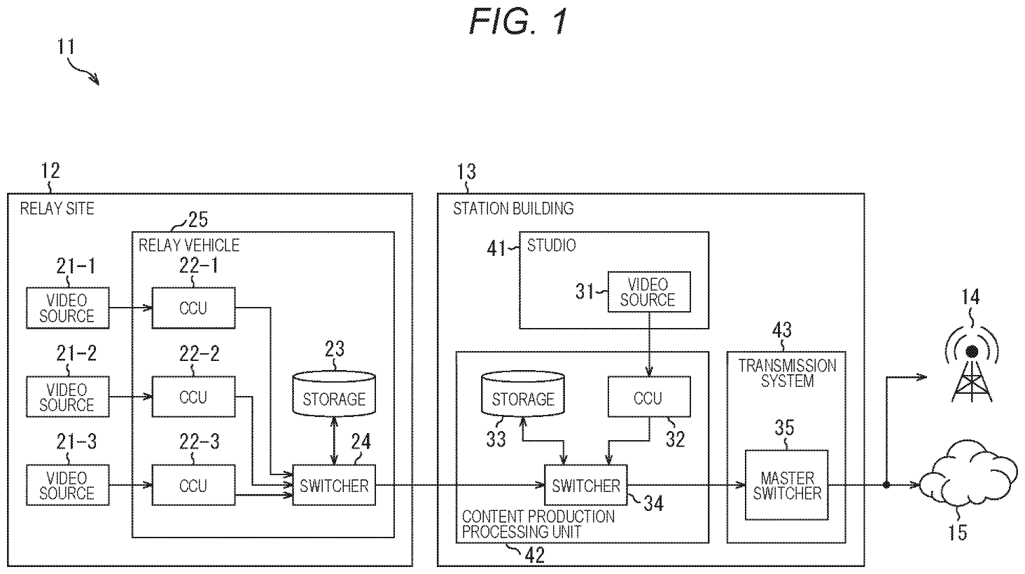

First, a configuration example of a broadcast content production system will be described with reference to FIGS. 1 to 3.

FIG. 1 is a block diagram illustrating a configuration example of a typical broadcast content production system mainly used for relaying or the like of sporting events and entertainment live shows and events.

A broadcast content production system 11 illustrated in FIG. 1 is configured such that a relay site 12 where relay is performed and station building 13 of a broadcaster are connected to each other through, for example, a dedicated line such as a satellite communication or the like. Furthermore, in the broadcast content production system 11, a broadcast content produced in the station building 13 is transmitted as a broadcast through a broadcast network 14, or is simultaneously distributed via the Internet via the network 15.

At the relay site 12, a plurality of video sources 21 is disposed, and devices such as camera control units (CCUs) 22, a storage 23, and a switcher 24 are mounted on a so-called relay vehicle 25 (or equipment referred to as an outside broadcasting van/truck (OBVAN/Truck)). In the example illustrated in FIG. 1, three video sources 21-1 to 21-3 are connected to the switcher 24 via the three CCUs 22-1 to 22-3.

The video sources 21-1 to 21-3 are each, for example, a camera that images a video for a broadcast content to be produced by the broadcast content production system 11, and the CCUs 22-1 to 22-3 respectively control imaging by the video sources 21-1 to 21-3. The videos imaged by the video sources 21-1 to 21-3 are supplied to the switcher 24 via the CCUs 22-1 to 22-3, respectively.

The storage 23 temporarily holds the videos from the video sources 21-1 to 21-3 to be supplied to the switcher 24. For example, these videos are used for replay or the like.

The switcher 24 transmits to the station building 13 the videos from the video sources 21-1 to 21-3 while switching the videos, or transmits to the station building 13 those videos and replay videos accumulated in the storage 23 while switching between those videos and the replay videos. Note that the switcher 24 is configured with a group of various devices for performing, in addition to such switching of videos, various types of processing that include superimposition of computer graphics and the like and relate to production of a broadcast content. For example, the switcher 24 can perform processing using a video held in the storage 23.

In the station building 13 there is provided equipment such as a video source 31, a CCU 32, a storage 33, a switcher 34, and a master switcher 35.

For example, the video source 31 is a camera that is disposed in a studio 41 to image a video, in addition to videos at the relay site, to be used for a broadcast content, and the video imaged by the video source 31 is supplied to the switcher 34 via the CCU 32.

The CCUs 32, the storage 33, and the switcher 34 are disposed in a content production processing unit 42 that is a production that performs production processing of a broadcast content.

The CCU 32 controls imaging by the video source 31, and the storage 33 temporarily holds a video to be supplied to the switcher 34. In a case where the switcher 34 uses the video imaged by the video source 31, the switcher 34 makes switching from the videos from the relay site 12 and performs production processing in the station building 13.

The master switcher 35 is disposed in a transmission system 43 that transmits a video from the station building 13. For example, the master switcher 35 switches from a non-main video, audio, and the like (specifically, commercial messages, news bulletins, and the like), and outputs a broadcast content to the broadcast network 14 or the network 15.

Conventionally, in the broadcast content production system 11 configured as described above, coaxial cables connect a device group disposed at the relay site 12 and a device group disposed in the station building 13 to each other. Furthermore, these device groups each operate in synchronization with one master clock.

For example, in a case where the switcher 24 switches the videos which are from a plurality of the video sources 31 and in which the same scene is imaged, the videos output from respective ones of the video sources 31 need to be synchronized with a certain accuracy. For example, in a case where switching is performed between videos that are not synchronized with each other, a subject does not move continuously, and the broadcast content makes viewers feel strange.

Here, as described above, the connection using coaxial cables has been replaced by an IP connection using the Ethernet. Also, in that case, it is possible to perform time synchronization with sufficient accuracy between, for example, devices IP-connected to one (physical) local area network (LAN) constituting the network of the relay vehicle 25 and the station building 13, by using the SMPTE profile (SMPTE ST 2059-2) of Precision Time Protocol (PTP, IEEE 1588), which is a standard protocol for synchronizing clocks (times) between IP-connected devices.

For example, a video stream output from the switcher 24 of the relay site 12 is transmitted to the station building 13 by using a satellite connection, a dedicated optical line, or the like. In a case where such transmission is performed through an IP connection, it is necessary to perform synchronization using the above-described PTP between the master clock of the relay site 12 and the master clock of the station building 13. However, even in a case where the IP connection is performed by a dedicated optical line, it is difficult to perform synchronization with sufficient accuracy in the case of using connection via a general Ethernet switch, an IP router, or the like.

For example, it has been reported that it is necessary to use a special device compatible with PTP (SMPTE profile) in order to perform synchronization with sufficient accuracy. However, for example, in a case where a video source 21 at the relay site 12 and the video source 31 in the studio 41 do not image the same scene, the synchronization accuracy of the master clocks of the relay site 12 and the station building 13 may be lower than in a case where cameras or the like capture images of the same scene.

By the way, as described above, currently, it is being considered to virtualize (cloudification) functions of a device group disposed in the relay vehicle 25 at the relay site 12 illustrated in FIG. 1 and a production device group other than the video source 31 in the station building 13, and it is also being considered to utilize a 5G wireless network and edge computing. A significant benefit of cloudification and utilizing edge computing is that the video sources 21 are wirelessly connected and that the function of the relay vehicle 25 is virtualized and cloudified. As a result, it is expected that the followings. There will be no need for wiring at the relay site 12, the relay vehicle 25, or equipment mounted on the relay vehicle 25. In addition, it is not necessary to send a person to operate.

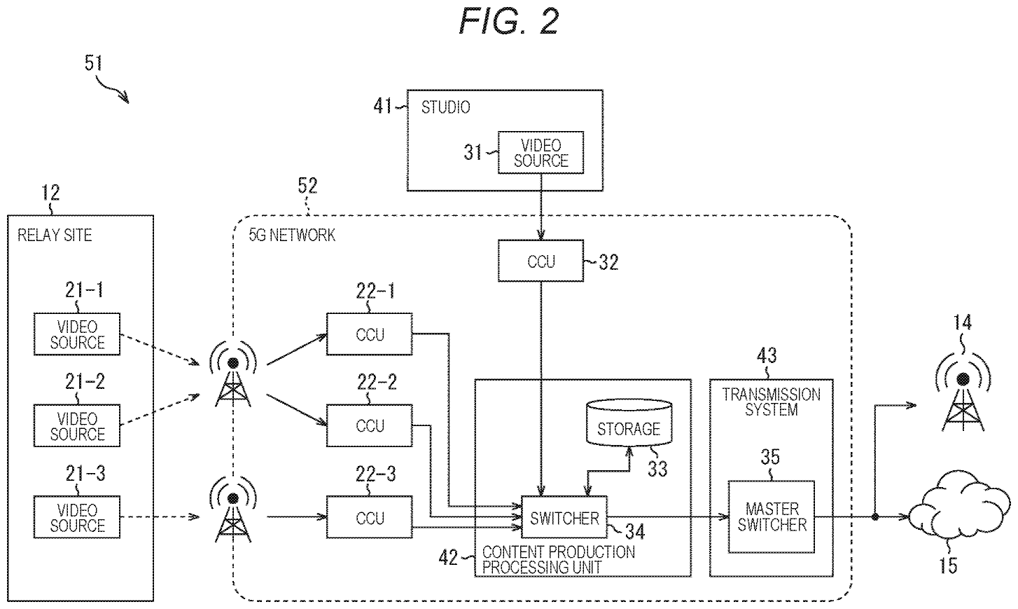

FIG. 2 is a block diagram illustrating a configuration of a content production system assuming a 5G wireless network. Note that, in a broadcast content production system 51 illustrated in FIG. 2, the same reference signs are given to blocks common to the broadcast content production system 11 in FIG. 1, and a detailed description thereof will be omitted.

In the broadcast content production system 51 illustrated in FIG. 2, the videos from the video sources 21-1 to 21-3 are connected to a 5G network 52 via wireless connection, and are directly transmitted to the content production processing unit 42 that is a virtual content production function on the cloud. In addition, the video source 31 in the studio 41 is also connected to the 5G network 52 via wired (or wireless) connection, and is transmitted to the content production processing unit 42, which is a virtual content production function.

For example, it is considered that that the functions of the CCUs 22-1 to 22-3 and the CCU 32 illustrated in FIG. 2 are also each virtualized and implemented as an application function (AF) in the 5G network 52.

By the way, in the broadcast content production system 11 illustrated in FIG. 1, the devices including the video sources 21-1 to 21-3 at the relay site 12 and the switcher 34 in the relay vehicle 25 operate in synchronization with one master clock. In contrast, in the broadcast content production system 51 illustrated in FIG. 2, the video sources 21-1 to 21-3 are connected to the switcher 34 included in the virtualized content production processing unit 42 via the 5G network 52, and it is expected that time synchronization with necessary accuracy cannot be necessarily performed as described above. Therefore, for example, in a case where the clocks of the video sources 21-1 to 21-3 at the relay site are synchronized with the master clock of the content production processing unit 42, it is considered that synchronization with sufficient accuracy cannot be achieved.

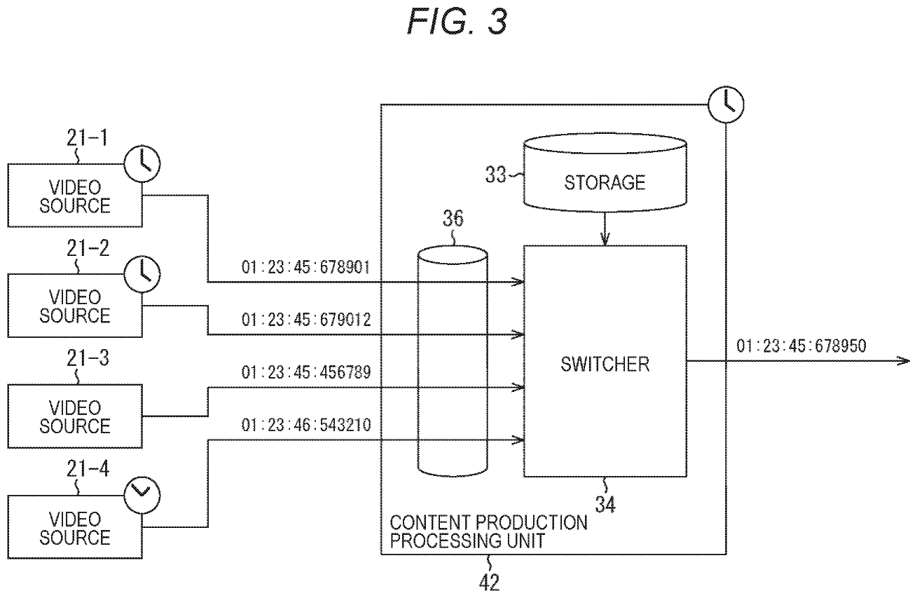

Furthermore, as illustrated in FIG. 3, in the broadcast content production system 11, synchronization adjustment is performed by a buffer 36 provided in an input part of the switcher 34 on the basis of timestamps added to the video streams by the video sources 21-1 to 21-4. However, in a case where the clocks (time) on which the timestamps are based are different with respect to individual video sources 21, the clocks cannot be correctly synchronized, and there is a concern that an inconvenience may occur in the broadcast content, depending on the kinds of processing on production.

Specifically, in a case where there is a difference between the times at which a subject is imaged by the video sources 21-1 to 21-3 (which means that the clocks on which the timestamps are based are not synchronized with each other with sufficient accuracy), inconsistency occurs in the following processing, for example: generating an image (video) by synthesizing videos from the plurality of video sources 21; displaying a plurality of videos side by side; switching the video sources 21; and the like. Therefore, it is important to know the synchronization accuracy of the clock of the individual video source 21, in the content production processing unit 42.

In the example illustrated in FIG. 3, since the timestamps of the streams from the two video sources 21-1 and 21-2 are added on the basis of sufficiently synchronized clocks, processing can be performed in the same manner as before. In contrast, for example, the timestamp of the stream from the video source 21-4 as which a smartphone is used is added on the basis of a clock that is not sufficiently synchronized. For this reason, even if synchronization adjustment is performed by the buffer 36, the synchronization is not correctly performed, and when such a stream is handled in the same manner as before, the above-described inconvenience occurs.

By the way, the master clock in the current broadcast content production system 11 is operated as follows. A clock generated by a master clock generator installed in a place such as the station building 13 where a global navigation satellite system (GNSS) signal can be stably received is distributed using the above-described SMPTE profile of PTP, and a certain accuracy (≤1 μs) is maintained. However, it is considered difficult to synchronize a clock between a master clock at the station building 13 and the content production processing unit 42 that is a virtualized content production function on the cloud, and it is also considered difficult to synchronize with sufficient accuracy, by using the PTP SMPTE profile, the clock of the video source 21 such as a camera connected via the 5G network 52 such as Radio Area Network or Core Network.

On the other hand, in the broadcast content production system 51 utilizing the 5G network 52, the following three means can be considered as means for obtaining the time at which the respective ones of devices and the functional units are synchronized with each other with sufficient accuracy; however, there is a problem in each of the three means, and it is not easy to utilize those means.

In a first means, it is considered that a device and an application, which serve as respective ones of the video sources, acquire a time from GNSS and utilize the acquired time. However, cameras and other devices accompanied by movement cannot always receive GNSS stably.

In the 5G system, each entity in the 5G system is synchronized by using a 5G system clock to implement the wireless communication of the 5G system, and it is considered to utilize the 5G system clock as a second means. If the 5G system clock can be acquired and used in each device or in the virtualized content production function unit, it is possible to achieve sufficient time synchronization accuracy. However, the time synchronization accuracy depends on how hardware or software is implemented in the device, and the resulting accuracy is on the order of tens of ms.

In the 5G system, it is attempted to support a mechanism of an Ethernet layer called Time Sensitive Networking (TSN: IEEE 802.1AS or the like), and it is considered to utilize TSN as a third means. For example, there is a possibility that time synchronization between the virtualized content production function unit on the network and the video source can be performed with a certain accuracy in an application layer by using TSN.

TSN also can achieve time synchronization using PTP; however, on the other hand, TSN uses an Ethernet layer, and TSN is therefore different from an SMPTE profile using an IP layer supported by an existing broadcast production system or device. In addition, an operation method for utilizing in a content production system for broadcasting has not been established yet, and it is unknown how much accuracy can be actually achieved. Furthermore, even if it is put into practical use, it takes time (and cost) for all devices used for broadcast production to become compatible with this means, and in addition, for smartphones of general users or applications thereof to become compatible with this means.

Putting together such three means and the respective problems, the following four study items need to be solved.

In the first study item, particularly in a case where a content is produced using a video imaged and uplinked by a smartphone of a general user or an application thereof, time accuracy of a clock (clock) on which the timestamp is based and which is added to a stream at each video source is not necessarily sufficient. That is, it is currently impossible to utilize a means for synchronizing time with sufficient accuracy, and it is necessary to solve this problem.

In the second study item, in a case where there are timestamps added on the basis of clocks with different time accuracy, when conventional content production processing is performed, it is sometimes inevitable that an inconvenience occurs in a processed video stream, depending on the content of production processing, and it is necessary to solve this problem.

In the third study item, in order to prevent the above problem, it is necessary to recognize, at least in the content production processing unit 42, the time accuracy of the clock on which the timestamp of each video stream is based. That is, since the production processing that can be performed by the content production processing unit 42 is different depending on the time accuracy of the source, it is necessary to recognize the time accuracy of the source.

In the fourth study item, with respect to a video stream whose original time accuracy is poor, it is necessary to estimate and correct a time difference between an accurate time and the clock of the source of the video stream in order to make a type of performable production processing be equivalent to the type of production processing for a stream with high synchronization accuracy.

In view of the above four study items, in the broadcast content production processing to which the present technology is applied, these study items are solved in an application (media) layer.

<Broadcast Content Production Processing to which Present Technology is Applied>

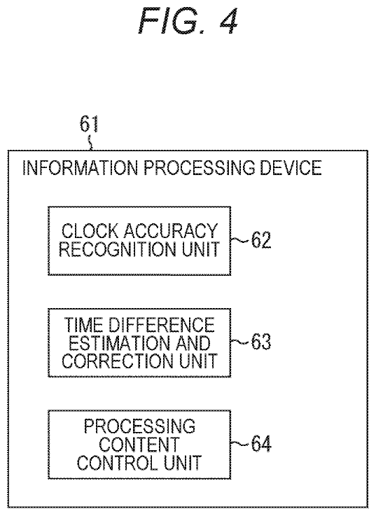

A broadcast content production processing to which the present technology is applied will be described with reference to FIGS. 4 to 20.

<Configuration Example of Information Processing Device>

FIG. 4 is a block diagram illustrating a configuration example of an information processing device that realizes broadcast content production processing to which the present technology is applied.

An information processing device 61 illustrated in FIG. 4 is realized by an application that performs broadcast content production processing, and includes a clock accuracy recognition unit 62, a time difference estimation and correction unit 63, and a processing content control unit 64.

Clock accuracy recognition unit 62 performs clock accuracy recognition processing for recognizing accuracy of the clock of each of the plurality of video sources 21. For example, the clock accuracy recognition unit 62 can recognize the accuracy of the clock of each video source 21 by using a negotiation protocol between each video source 21 and the network to which the video sources 21 is connected. Alternatively, the clock accuracy recognition unit 62 can recognize the accuracy of the clock of each video source 21 on the basis of the fact that information indicating the clock accuracy is added, by each video source 21, to the timestamp information embedded in a stream.

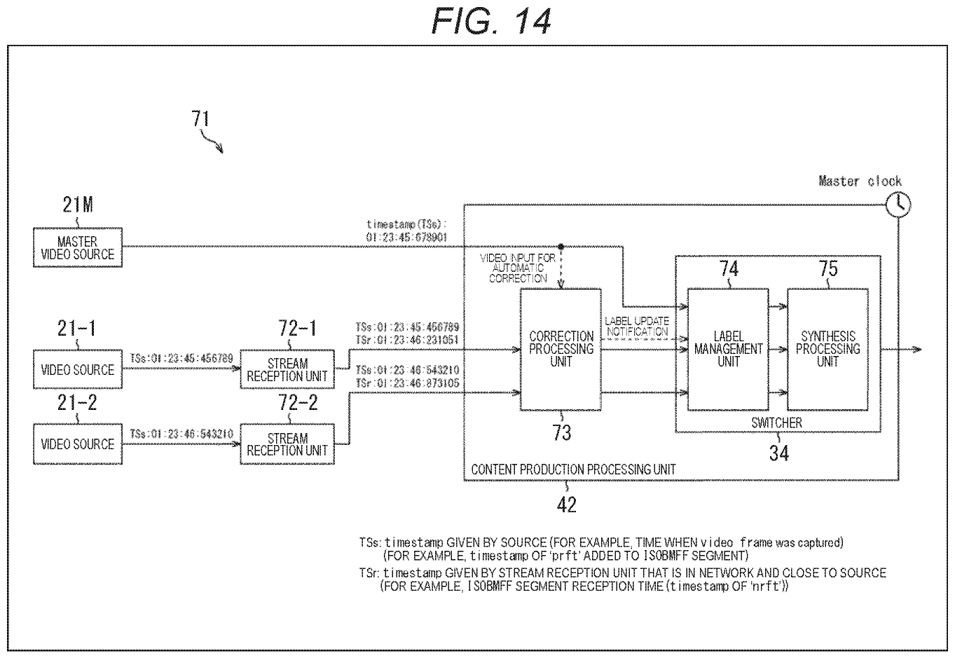

The time difference estimation and correction unit 63 estimates a time difference of a stream with low accuracy of clock and performs time difference estimation and correction processing that corrects the time difference. For example, the time difference estimation and correction unit 63 can estimate, as described later, a time difference by performing statistical processing on a time gap between time information used as a reference by the video source 21 and time information added by the stream reception unit 72 (FIG. 14) that receives the stream output from the video source 21.

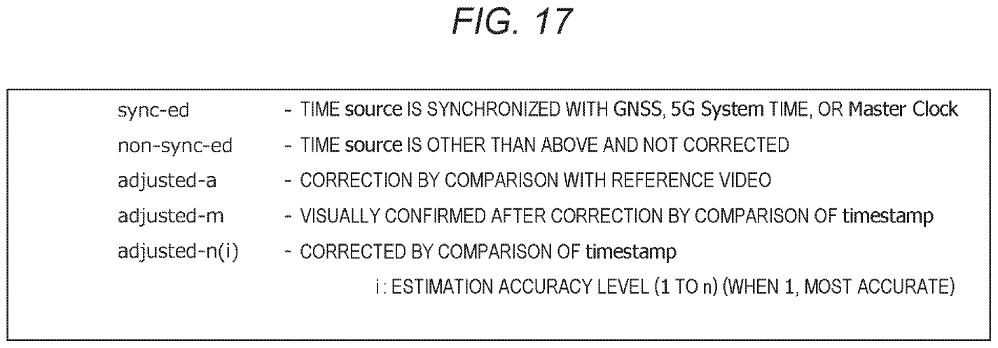

The processing content control unit 64 performs processing content control processing that controls the processing content of the content production processing in accordance with the clock accuracy of the video source 21 and with the accuracy of the time information (timestamp) of each stream whose time information has been corrected by the time difference estimation and correction unit 63. For example, the processing content control unit 64 can set, for each video source 21 of the video stream, a time accuracy label as illustrated in FIG. 17 as described later, and can automatically control the processing content on the basis of the time accuracy label. Furthermore, the processing content control unit 64 can update the time accuracy label of each video source 21.

<Clock Accuracy Recognition Processing>

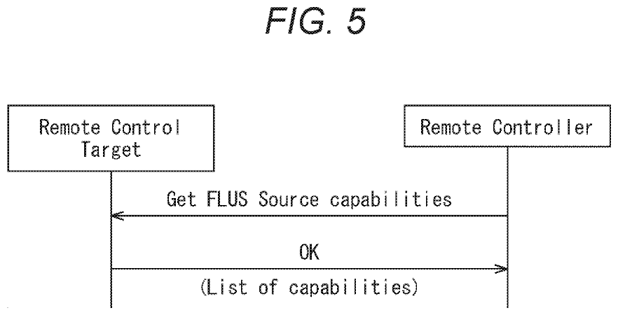

The clock accuracy recognition processing performed in the clock accuracy recognition unit 62 will be described with reference to FIGS. 5 to 10.

First, a description will be given to the clock accuracy recognition processing in which the clock accuracy recognition unit 62 can recognize the accuracy of the clock of each video source 21 by using a negotiation protocol between each video source 21 and the network to which the video source 21 is connected.

For example, the clock accuracy recognition unit 62 is provided as a means by which the content production processing unit 42 acquires the time accuracy of a video source 21 having a specific function. For example, in the Framework for Uplink Streaming (FLUS) in which standardization is being progressed by the 3GPP TSG SA WG4, there is FLUS Source Capability Discovery as illustrated in FIG. 5 as a protocol in which a FLUS Sink acquires capability of a FLUS Source. The FLUS Sink (Remote Controller) is an application function that receives an Uplink Streaming, and the FLUS Source (Remote Control Target) is a function on user equipment (UE) that performs Uplink Streaming.

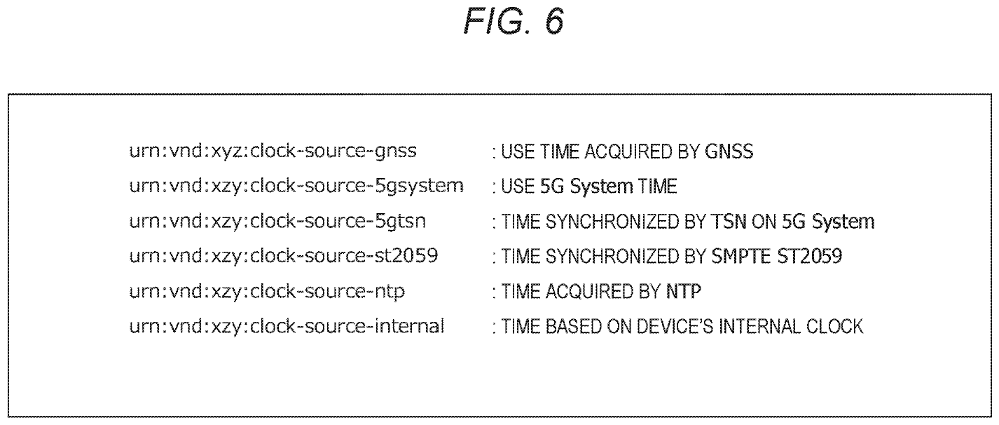

Then, in such a protocol, the capability as illustrated in FIG. 6 is defined so that the FLUS Sink can obtain the type of the time source included in the FLUS Source. Here, “vnd:xyz” illustrated in FIG. 6 is a character string satisfying the URN definition.

For example, the clock accuracy recognition unit 62 has a function as a Remote FLUS Controller, acquires a capability from the FLUS Source included in the video source 21, and notifies a Media Application (Production) that is the content production processing unit 42, of the capability.

Next, a description will be given to the clock accuracy recognition processing in which the clock accuracy recognition unit 62 recognizes the accuracy of the clock of each video source 21 on the basis of the fact that information indicating the clock accuracy is added to the timestamp information embedded in a stream by the video source 21.

As a format of the Uplink Streaming used for broadcast content production, a format defined in SMPTE ST 2110 can be considered in addition to an ISOBMFF segment in accordance to MPEG DASH. In the case of the SMPTE ST 2110 format, the time when the video (or audio) of a payload is captured is recorded in the timestamp of an RTP packet header. A type of a time source on which a timestamp is based can be defined as an extension header. On the other hand, in the case of ISOBMFF, a timestamp can be described, for a similar purpose, for each individual segment using a Producer Reference Time Box (‘prft’).

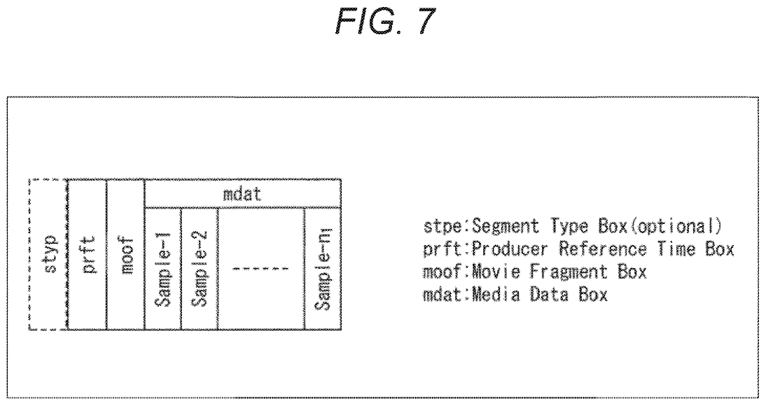

FIG. 7 illustrates an example of an ISOBMFF segment including a ‘prft’ box.

In the ISOBMFF segment illustrated in FIG. 7, the ‘prft’ box is a file level box and must always be placed before the first ‘moof’ box of each segment.

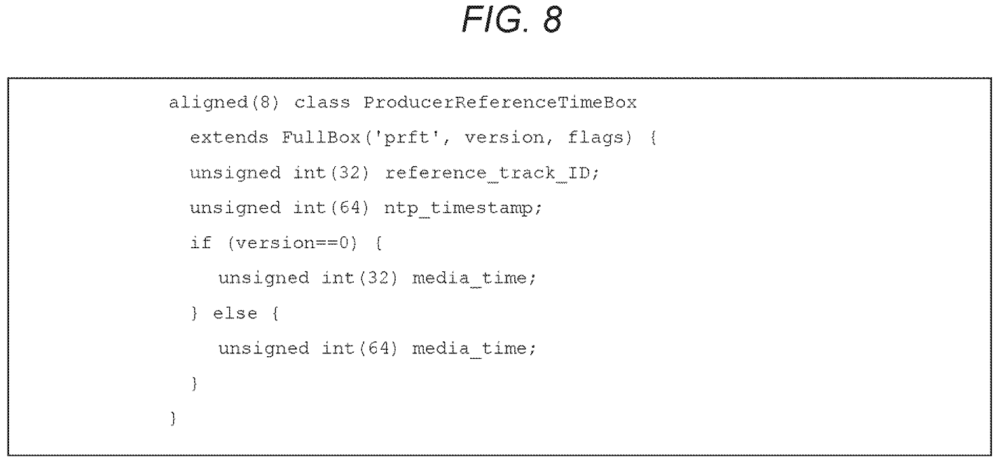

In addition, the syntax of the ‘prft’ box is illustrated in FIG. 8 and represents the relationship between the time indicated by ntp_timestamp by using the value of flags and the data (video or audio data) included in the sample corresponding to the media time (the beginning of the file is 0) in the ISOBMFF indicated by media_time. The type of the relationship is defined by the time of being captured, the time of being input to an encoder, the time of being output from the encoder, and the like, and can be specified by the value of flags, thereby being properly used in accordance with purposes.

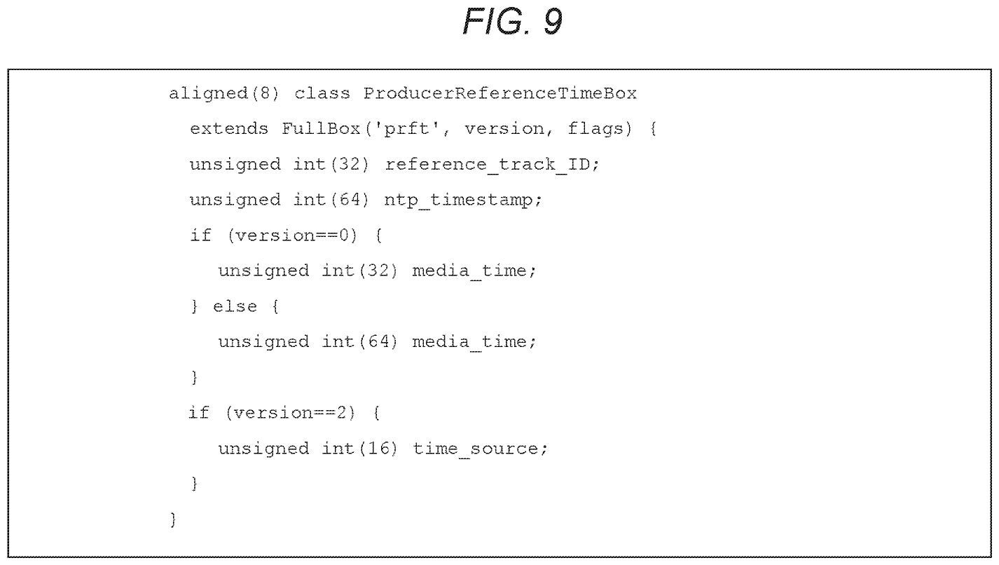

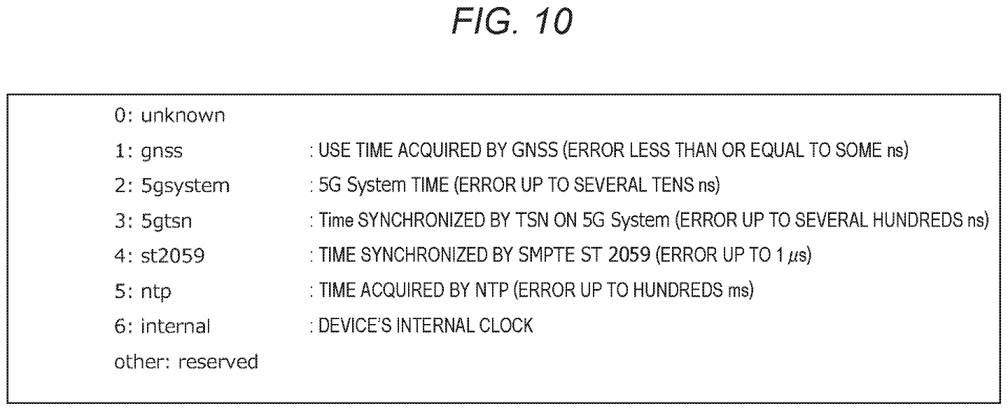

Here, in order to represent the time source on which the timestamp is based, expansion is performed as illustrated in FIG. 9, for example. Furthermore, the value of the time_source field is as illustrated in FIG. 10. Note that the parentheses in FIG. 10 are rough indications of synchronization accuracy of each time source. Alternatively, the type of the time_source field may be specified to be the UTF-8 String, and in addition, a character string (gnss, 5gsystem, 5gtsn, st2059, etc.) indicated after “:” of each field value (integer) illustrated in FIG. 10 may be written.

Then, the content production processing unit 42 can recognize, by way of the clock accuracy recognition unit 62, the accuracy of the time on which the timestamp of each video source 21 is based, so that it can be determined which production processing the video source 21 can be used for.

<Time Difference Estimation and Correction Processing>

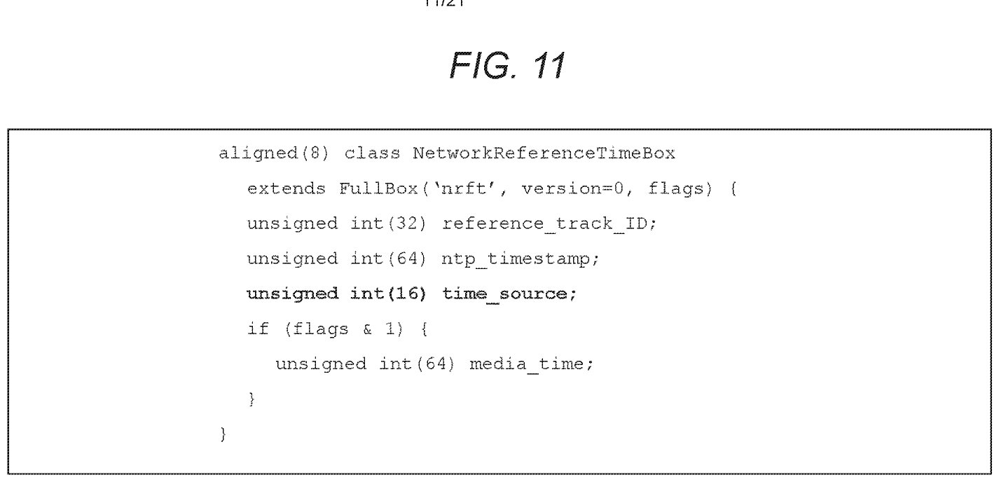

The time difference estimation and correction processing performed by the time difference estimation and correction unit 63 will be described with reference to FIGS. 11 to 13.

For example, the time difference estimation and correction unit 63 can estimate and correct a time difference for a stream with low time accuracy, for example, in a case where the video source 21 uses the time acquired by NTP. Furthermore, a description will be given here only to a case where the ISOBMFF segment is used as the stream format. However, in the case of the SMPTE 2110 format, an equivalent can be realized by applying extension (addition of description content) similar to what will be described below, to the extension header of the RTP packet.

First, each video source 21 places a function such as the above-described FLUS Sink at a location that is closest to the video source 21 and is connected to the 5G network 52 via wireless access, and a new Box in which a reception time is written is added to a segment received by the function from the video source 21. Note that the function such as the FLUS Sink will be described later as a stream reception unit 72 illustrated in FIG. 14.

For example, the Box is referred to as a Network Reference Time Box (‘nrft’). At this time, the function that adds the ‘nrft’ box is a function defined as the 5G System, and it is assumed that a 5G System time can be acquired or that the function has been time synchronized with the content production processing unit 42 by TSN on the 5G System.

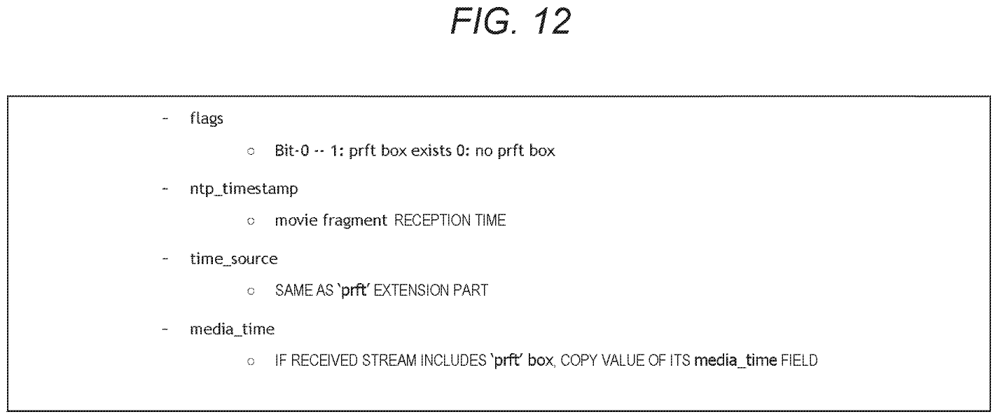

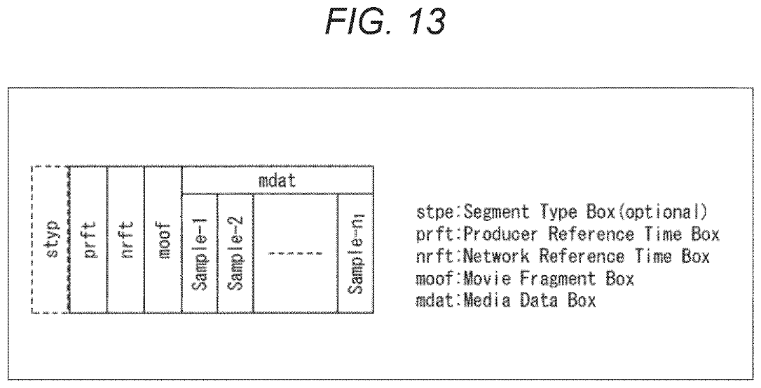

Then, the syntax of the ‘nrft’ box is defined as illustrated in FIG. 11, and the Semantics is as illustrated in FIG. 12. Furthermore, FIG. 13 illustrates an example of the ISOBMFF segment to which the ‘nrft’ box is added.

<Configuration Example of Broadcast Content Production System>

FIG. 14 is a block diagram illustrating a configuration example of a broadcast content production system 71 having a function of performing time correction on a source with low accuracy. Note that, in the broadcast content production system 71 illustrated in FIG. 14, the same reference signs are given to the blocks common to the broadcast content production system 51 in FIG. 2, and the detailed description thereof is omitted. In addition, the broadcast content production system 71 in FIG. 14 includes similar blocks (not illustrated) to those of the broadcast content production system 51 in FIG. 2.

In the broadcast content production system 71 illustrated in FIG. 14, the video from a master video source 21M is directly supplied to the content production processing unit 42, and videos from video sources 21-1 and 21-2 are respectively supplied to the content production processing unit 42 through stream reception units 72-1 and 72-2.

The content production processing unit 42 includes a correction processing unit 73 on the input side of the content production processing unit 42, and a switcher 34 includes a label management unit 74 and a synthesis processing unit 75. Note that the clock accuracy recognition unit 62, the time difference estimation and correction unit 63, and the processing content control unit 64 of the information processing device 61 illustrated in FIG. 4 can be implemented as functions of the correction processing unit 73.

A procedure of time correction in the broadcast content production system 71 configured as described above will be described.

The video sources 21 each add the ‘prft’ box, described above with reference to FIG. 7, to the ISOBMFF segment. At this time, the relationship (that is, the setting of the flag) between the time of the timestamp and the data (video or audio) stored in the sample corresponding to the value of the media_time field is the time of being captured by the video source 21, the time of being input to the encoder, or the time of being output from the encoder. Note that, in order to improve the accuracy of the estimation of the time difference by the time difference estimation and correction unit 63, it is desirable to use the output time from the encoder. Furthermore, assuming that the statistical fluctuation of the required time from capturing by the video source 21 to entering into the encoder or from entering the encoder to outputting from the encoder is sufficiently small (compared with the fluctuation of the transmission time), the estimation accuracy of the time difference is not large in a case where one of these three type of timestamps is used.

The stream reception units 72 each record the time at which the ‘moof’ box of the ISOBMFF segment as illustrated in FIG. 7 is received on the basis of its own clock, and generate the ‘nrft’ box and adds the ‘nrft’ box to the segment as illustrated in above-described FIG. 13.

Then, the correction processing unit 73 in the content production processing unit 42 observes the timestamp described in the ‘prft’ box and the ‘nrft’ box, and estimates the time difference between the video source 21 and the clock of the stream reception unit 72 (and the content production processing unit 42) by the processing as described below.

As a premise, it is assumed that the video sources 21 each always perform time synchronization by some means (for example, NTP), and neither a time Ts serving as a reference of the video source 21 nor a time Tr of the stream reception unit 72 drifts, so that a time difference Tdiff (=Tr−Ts) between the two clocks always falls within a certain range. That is, in a case where the time on which the timestamp is based and which is added by the video source 21 is the internal clock of the device (for example, when a value of the time_source field is “internal”), the accuracy of the corrected time is not guaranteed in a case where the time difference estimation and correction processing is performed.

Here, in a case where a timestamp time TSs of ‘prft’ is an encoder output time, the time gap between the timestamp time TSs of ‘prft’ and the timestamp time TSr of ‘nrft’ includes, in addition to the time difference Tdiff, a transmission delay Ttr that is a time from being output from an encoder of a video source to arriving at a stream reception unit. Therefore, the relationship of the following equation (1) is established.

TSr−TSs=Tdiff+Ttr (1)

If the transmission delay Ttr can be estimated from this equation (1), the value of the time difference Tdiff can be obtained, and by adding the time difference Tdiff to the timestamp time, it is possible to obtain the timestamp time in which the difference between the reference times of the video source 21 and the stream reception unit 72 (and the content production processing unit 42) is corrected.

Here, it is assumed that each stream reception unit 72 measures a round trip time (RTT) in order to estimate a network transmission delay between itself and the video source 21. However, because the transmission delay on the network usually varies, a value TRTT of the RTT measured by the stream reception unit 72 and the value of the time gap (TSr−TSs) between the timestamp time TSs of ‘prft’ and the timestamp time TSr of ‘nrft’ also similarly varies, and, as a result, the value of the time difference Tdiff also varies.

Therefore, the stream reception unit 72 obtains a standard value of the time gap (TSr−TSs) by statistically processing the value of the time gap (TSr−TSs) of each segment while receiving a plurality of segments in a certain period. On the other hand, the stream reception units 72 each can obtain an estimated value of the transmission delay Ttr by performing measurement of the RTT at the frequency of receiving the segment in such a manner that the relationship with the reception of the segment data can be always the same timing, and by performing similar statistical processing also on the value TRTT of the RTT. Then, the stream reception unit 72 can obtain the estimated value of the time difference Tdiff by using those values and by subtracting the estimated value of the transmission delay Ttr from the value of the standard time gap (TSr−TSs), in which the subtraction is ((TSr−TSs)−Ttr).

The estimation of the value by the statistical process performed here can be done by using a simple average, a trim average, a median value, or the like, for example.

In addition, an estimation accuracy of the Tdiff can be made to have a level by using: a length of a period for which the statistical processing is performed; a magnitude of the variance of the time gap (TSr−TSs) and the value TRTT of the RTT; the difference between the median or the mode (range) and the average value; or the like. This level value (i) can be used for time accuracy labeling for each video source 21 as described later with reference to FIG. 17.

By the way, this time correction can also be performed in the stream reception units 72 instead of being performed in the correction processing unit 73 in the content production processing unit 42. In that case, the stream reception units 72 each add a Network Adjusted Reference Time Box (‘nart’) in addition to adding the above-described ‘nrft’ box.

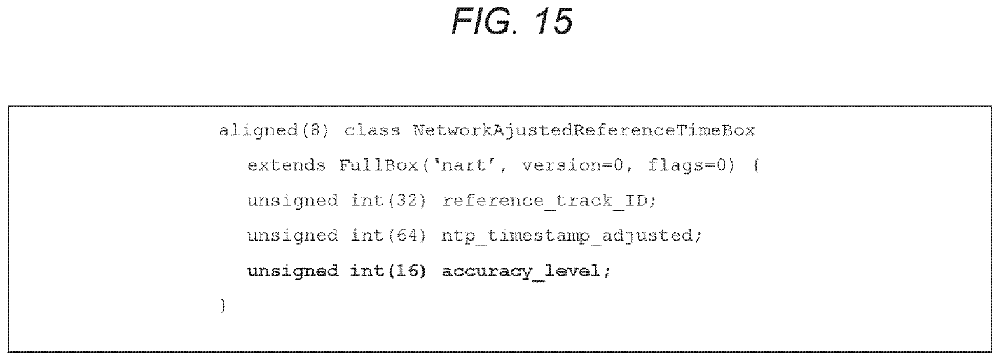

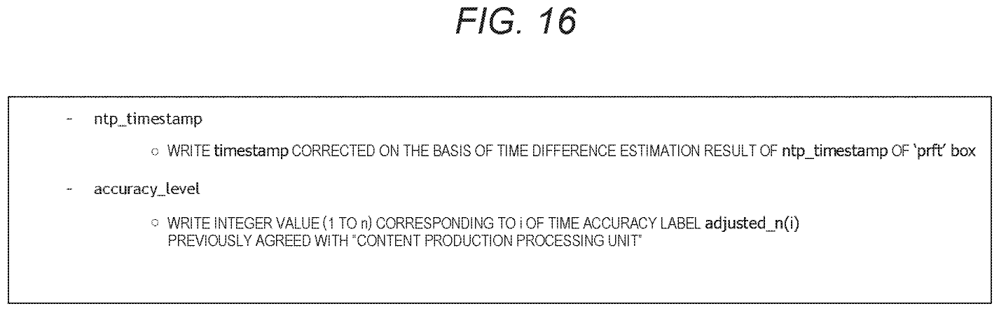

Therefore, the syntax of the ‘nart’ box is as illustrated in FIG. 15, and the Semantics is as illustrated in FIG. 16.

In this way, the correction in the content production processing unit 42 can be omitted, and the processing using the result of the correction by the stream reception units 72 can be performed.

By performing such correction processing of a timestamp reference time, the processing content control unit 64 can control the processing content so that a wider range of production processing is performed also on a content that has a low time accuracy on which the timestamp added by the video source 21 is based. That is, the processing content control unit 64 controls the processing content of the content production processing as described below in accordance with the clock accuracy of the video source 21 recognized by the clock accuracy recognition unit 62 and with the accuracy of the time information (timestamp) of each stream corrected in the time difference estimation and correction unit 63.

First, the processing content control unit 64 attaches the time accuracy label illustrated in FIG. 17 to the stream from each video source 21. This time accuracy label is not written in the stream, but is metadata allocated to each input port of the switcher 34, for example. For example, the time accuracy label corresponds to metadata given to Flow stipulated by the NMOS standard specified by AMWA (Advanced Media Workflow Association).

Then, after labeling of the time accuracy label, the processing content control unit 64 notifies the switcher 34 that the label is update. In response to this notification, in the switcher 34, the label management unit 74 verifies the time accuracy label and corrects the label, and the synthesis processing unit 75 performs processing (synthesis of videos, multi-display, switching, replay, and the like) in accordance with the time accuracy label.

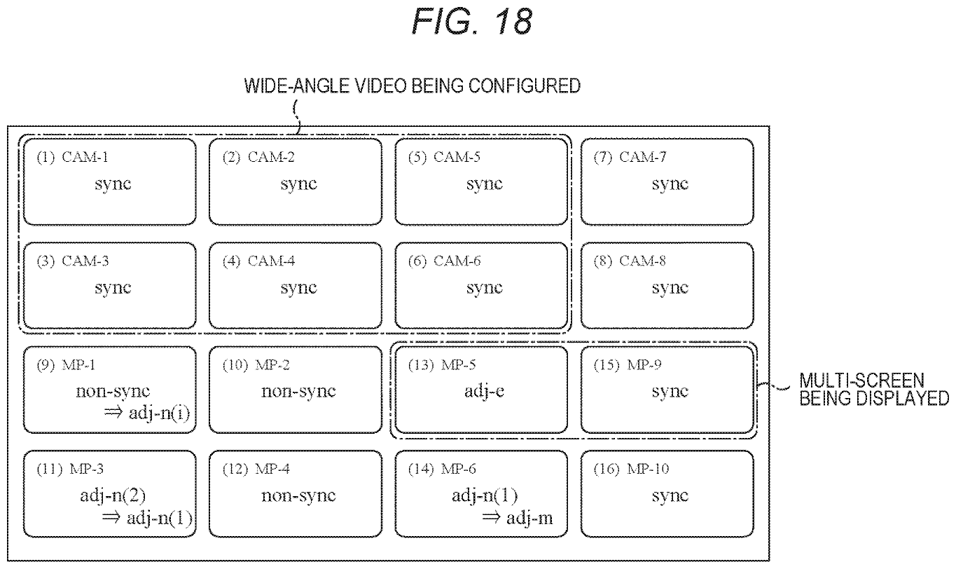

For example, FIG. 18 illustrates a display example of a monitor screen on which videos (1) to (16) in which the streams from 16 video sources 21 are labeled.

For example, the monitor screen shows that a wide-angle video is being configured while the videos (1) to (6) are being synthesized, and shows that the video (13) and the video (15) are being displayed as a multi-screen. In addition, the video (11) shows that the label has been changed in response to improvement of the estimation accuracy with time. Furthermore, the video (13) shows that the video (13) has been corrected by comparing frame images with the reference video (16). The video (14) shows that the label has been changed by visual comparison and confirmation with the reference video (16).

Note that there is a possibility that these labels will be changed as needed in the following cases: a case where the estimation accuracy is improved with time by the time difference estimation and correction unit 63; a case where an artificial manipulation (confirmation by visual observation or the like) has been made; a case where synchronization correction using a reference video is achieved; and the like.

Here, as a content of the content production processing, the following images are considered: an ultra-wide-angle video in which a plurality of streams is connected; a multi-screen video with streams from a plurality of viewpoints; a video made by switching a plurality of source videos; and a replay video from different viewpoints. Note that the content production processing is not limited to these videos, and other videos may be a content of the content production processing.

For example, the ultra-wide-angle video in which a plurality of streams is connected is usually performed on streams in which various settings such as a disposition position, an imaging angle, an angle of view, a focal point, and the like of each video source 21 have been adjusted, and it is considered that the clocks (times) on which the timestamps are based are synchronized in many cases. However, in recent years, there has been made also a technology with which connection can be made by processing after imaging even if precise adjustment is not previously performed, and there is a possibility that synthesis from a plurality of streams that are not necessarily time synchronized will be performed.

Furthermore, the multi-screen video of streams from a plurality of viewpoints has a possibility that, if synchronization is not performed with high accuracy, an unnatural screen is formed in the case of displaying, side by side, videos in which a moving subject is imaged by video sources 21 from different angles.

Similarly, the video made by switching the plurality of video sources 21 has a possibility that movement is unnatural in the case of switching a plurality of videos showing the same actively moving subject.

On the other hand, with respect to replay videos imaged from different viewpoints, the time accuracy on which the timestamps are based does not matter much unless the replay videos are displayed simultaneously (being synchronized) with videos from the other video sources 21.

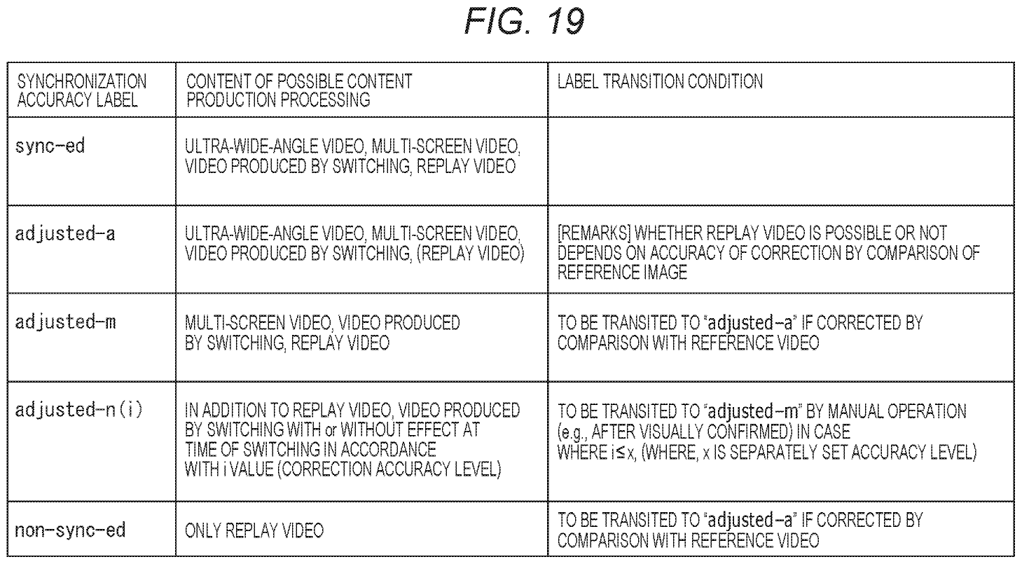

Therefore, the processing content control unit 64 controls the processing content of the content production processing so that only the processing described in FIG. 19 can be performed in accordance with the time accuracy label as illustrated in FIG. 19. Note that the processing contents illustrated in FIG. 19 are examples, and other processing contents may be used.

As described above, by labeling in accordance with the clock (time) accuracy of each video source 21 and by performing label management in which a correction state of a time difference is reflected as needed, it is possible to maximally effectively use the stream materials from all the video sources 21 in content production in which a general user terminal such as a smartphone is used as the video source 21.

<Processing Example of Information Processing>

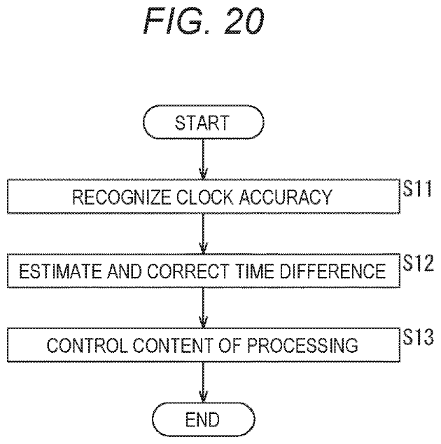

FIG. 20 is a flowchart illustrating information processing executed by the information processing device 61 in FIG. 4.

In step S11, the clock accuracy recognition unit 62 recognizes the accuracy of the clock for each video source 21. For example, the clock accuracy recognition unit 62 can use a negotiation protocol with a network to which the video source 21 is connected, or can use the timestamp information that the video source 21 embeds in a stream.

In step S12, the time difference estimation and correction unit 63 estimates the time difference of a stream with low time accuracy and corrects the time difference.

In step S13, the processing content control unit 64 controls the processing content of the content production processing in accordance with the clock accuracy of the video source 21 and with the accuracy of the time information (timestamp) of each stream whose time information has been corrected by the time difference estimation and correction unit 63. For example, the processing content control unit 64 gives a time accuracy label as illustrated in FIG. 19, and control is conducted on a content production processing such as synthesizing videos in the synthesis processing unit 75 according to the management of the time accuracy label by the label management unit 74.

<Configuration Example of Computer>

Next, the above-described series of processing (broadcast content production method) can be performed by hardware or software. In a case where a series of processing is performed by software, a program constituting the software is installed in a general-purpose computer or the like.

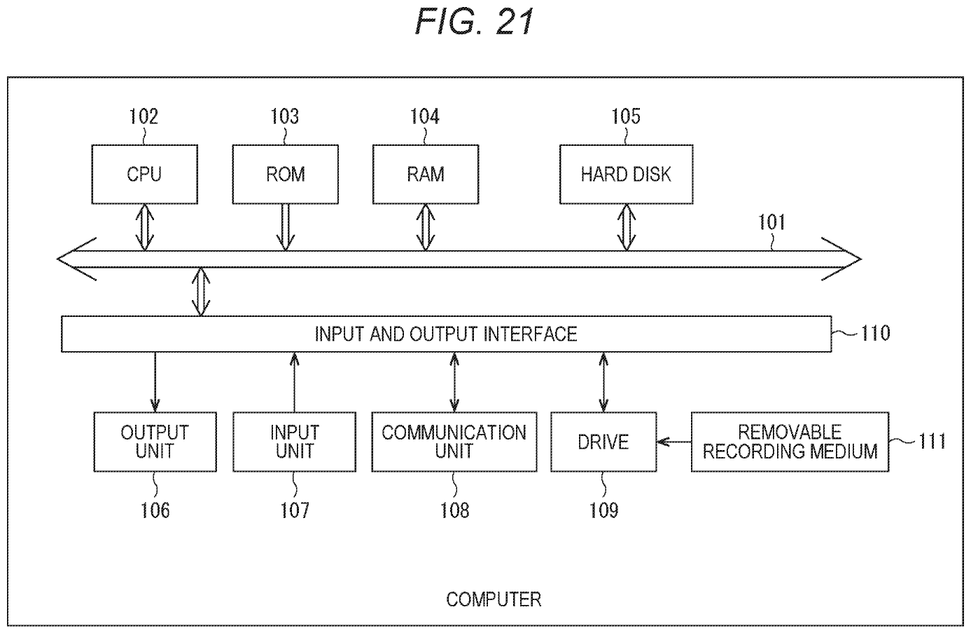

FIG. 21 is a block diagram illustrating a configuration example of an embodiment of a computer in which a program for performing the above-described series of processing is installed.

The program can be recorded in advance in a hard disk 105 or a ROM 103 as a recording medium built in a computer.

Alternatively, the program can be stored (recorded) in a removable recording medium 111 driven by a drive 109. Such a removable recording medium 111 can be provided as so-called package software. Here, examples of the removable recording medium 111 include a flexible disk, a compact disc read only memory (CD-ROM), a magneto optical (MO) disk, a digital versatile disc (DVD), a magnetic disk, a semiconductor memory, and the like.

Note that, instead of installing the program in the computer from the removable recording medium 111 as described above, the program can be downloaded to the computer via a communication network or a broadcast network and can be installed in the embedded hard disk 105. That is, for example, the program can be wirelessly transferred from a download site to the computer via an artificial satellite for digital satellite broadcasting, or can be transferred by wire to the computer via a network such as a local area network (LAN) or the Internet.

The computer incorporates a central processing unit (CPU) 102, and an input and output interface 110 is connected to the CPU 102 via a bus 101.

When an instruction is input via the input and output interface 110 by a user performing an operation or the like on an input unit 107, the CPU 102 executes a program stored in the read only memory (ROM) 103, according to the instruction. Alternatively, the CPU 102 loads a program stored in the hard disk 105 into a random access memory (RAM) 104 and executes the program.

As a result, the CPU 102 performs the processing according to the above-described flowchart or performs the processing that is performed by the configuration of the above-described block diagram. Then, as necessary, the CPU 102 outputs or transmits a processing result, for example, from an output unit 106 or a communication unit 108 via the input and output interface 110, or performs recording or the like of the processing result in the hard disk 105.

Note that the input unit 107 includes a keyboard, a mouse, a microphone, and the like. Furthermore, the output unit 106 includes a liquid crystal display (LCD), a speaker, and the like.

Here, in the present specification, the processing performed by the computer according to the program is not necessarily performed in time series in the order described as the flowchart. That is, the processing performed by the computer according to the program also includes processing performed in parallel or individually (for example, parallel processing or processing by object).

Furthermore, the program may be processed by a single computer (processor) or may be distributed and processed by a plurality of computers. Furthermore, the program may be transferred to a computer and be executed.

Furthermore, in the present specification, a system means a set of a plurality of components (devices, modules (parts), and the like), and it does not matter whether or not all the components are in the same housing. Therefore, the following devices are both systems: a plurality of devices housed in separate housings and connected via a network; and one device in which a plurality of modules is housed in one housing.

Furthermore, for example, a configuration described as one device (or one processing unit) may be divided and may be configured as a plurality of devices (or processing units). Conversely, the configurations described above as a plurality of devices (or processing units) may be collectively configured as one device (or one processing unit). Furthermore, a configuration other than the above-described configurations may be added to the configuration of each device (or each processing unit). Furthermore, as long as the configuration and the operation of an entire system are substantially the same, a part of the configuration of a certain device (or a certain processing unit) may be included in the configuration of another device (or another processing unit).

Furthermore, for example, the present technology can have a configuration of cloud computing in which one function is shared and processed in cooperation by a plurality of devices via a network.

Furthermore, for example, the above-described program can be executed in an arbitrary device. In that case, the device is only required to have a necessary function (functional block or the like) so as to be able to obtain necessary information.

Furthermore, for example, each step described in the above-described flowchart can be executed by one device or can be shared and executed by a plurality of devices. Furthermore, in a case where a plurality of processes is included in one step, the plurality of processes included in the one step can be executed by one device or can be shared and executed by a plurality of devices. In other words, a plurality of processes included in one step can also be executed as processes of a plurality of steps. Conversely, the processing described as a plurality of steps can be collectively executed as one step.

Note that, a program executed by the computer may be made as follows. Processing of steps describing the program may be executed in time series in the order described in the present specification, or may be executed in parallel or may be executed individually at necessary timing such as when called. That is, as long as there is no contradiction, the processing of each step may be performed in an order different from the above-described order. Furthermore, the processing of steps describing this program may be performed in parallel to processing of another program, or may be performed in combination with processing of another program.

Note that a plurality of the present technologies described in the present specification can be practiced independently as a single body as long as there is no contradiction. Of course, an arbitrary number of the present technologies can be practiced in combination. For example, some or all of the present technologies described in any of the embodiments can be implemented in combination with some or all of the present technologies described in other embodiments. Furthermore, some or all of the above-described arbitrary present technologies can be practiced in combination with other technologies not described above.

<Combination Example of Configuration>

Note that the present technology can also have the following configurations.

(1)

A broadcast content production system including:

a clock accuracy recognition unit that recognizes accuracy of a clock of each of a plurality of video sources; and

a time difference estimation and correction unit that estimates a time difference of a stream from a video source, of the plurality of video sources, with low accuracy of clock and corrects the time difference.

(2)

The broadcast content production system according to above-described item (1), further including:

a processing content control unit configured to control a processing content of production processing of the broadcast content in accordance with the accuracy of the clock of each of the video sources recognized by the clock accuracy recognition unit and with accuracy of time information, of each stream, having being corrected by the time difference estimation and correction unit.

(3)

The broadcast content production system according to above-described item (1) or (2), in which

the clock accuracy recognition unit recognizes the accuracy of the clock of each of the video sources by using a negotiation protocol with a network to which the each of the video sources is connected.

(4)

The broadcast content production system according to above-described item (1) or (2), in which

the clock accuracy recognition unit recognizes the accuracy of the clock of each of the video sources by using information that represents clock accuracy and is added to timestamp information embedded in the stream by the each of the video sources.

(5)

The broadcast content production system according to any one of above-described items (1) to (4), in which

the time difference estimation and correction unit estimates the time difference by statistically processing a time gap between time information on which each of the video sources is based and time information added by a stream reception unit that receives a stream having been output from the each of the video sources.

(6)

A broadcast content production method performed by a broadcast content production system, the method including:

recognizing accuracy of a clock of each of a plurality of video sources; and

estimating a time difference of a stream from a video source, of the plurality of video sources, with low accuracy of clock and correcting the time difference.

(7)

A program for causing a computer of a broadcast content production system to perform:

recognizing accuracy of a clock of each of a plurality of video sources; and

estimating a time difference of a stream from a video source, of the plurality of video sources, with low accuracy of clock and correcting the time difference.

Note that the present embodiment is not limited to the above-described embodiment, and various modifications can be made without departing from the gist of the present disclosure. Furthermore, the effects described in the present specification are merely examples and are not limited, and other effects may be provided.

### REFERENCE SIGNS LIST

11 Broadcast content production system
12 Relay site
13 Station building
14 Broadcast network
15 Network
21 Video source
22 CCU
23 Storage
24 Switcher
25 Relay vehicle
31 Video source
32 CCU
33 Storage
34 Switcher
35 Master switcher
36 Buffer
41 Broadcast content production system
42 Content production processing unit
43 Transmission system
51 Broadcast content production system
52 5G network
61 Information processing device
62 Clock accuracy recognition unit
63 Time difference estimation and correction unit
64 Processing content control unit
71 Broadcast content production system
72 Stream reception unit
73 Correction processing unit
74 Label management unit
75 Synthesis processing unit

1. A broadcast content production system comprising:
a clock accuracy recognition unit that recognizes accuracy of a clock of each of a plurality of video sources; and
a time difference estimation and correction unit that estimates a time difference of a stream from a video source, of the plurality of video sources, with low accuracy of clock and corrects the time difference.

2. The broadcast content production system according to claim 1, further comprising:
a processing content control unit configured to control a processing content of production processing of the broadcast content in accordance with the accuracy of the clock of each of the video sources recognized by the clock accuracy recognition unit and with accuracy of time information, of each stream, having being corrected by the time difference estimation and correction unit.

3. The broadcast content production system according to claim 1, wherein
the clock accuracy recognition unit recognizes the accuracy of the clock of each of the video sources by using a negotiation protocol with a network to which the each of the video sources is connected.

4. The broadcast content production system according to claim 1, wherein
the clock accuracy recognition unit recognizes the accuracy of the clock of each of the video sources by using information that represents clock accuracy and is added to timestamp information embedded in the stream by the each of the video sources.

5. The broadcast content production system according to claim 1, wherein
the time difference estimation and correction unit estimates the time difference by statistically processing a time gap between time information on which each of the video sources is based and time information added by a stream reception unit that receives a stream having been output from the each of the video sources.

6. A broadcast content production method performed by a broadcast content production system, the method comprising:
recognizing accuracy of a clock of each of a plurality of video sources; and
estimating a time difference of a stream from a video source, of the plurality of video sources, with low accuracy of clock and correcting the time difference.

7. A program for causing a computer of a broadcast content production system to perform:
recognizing accuracy of a clock of each of a plurality of video sources; and
estimating a time difference of a stream from a video source, of the plurality of video sources, with low accuracy of clock and correcting the time difference.
